(19) United States
(12) Patent Application Publication
(10) Pub. No.: US 2018/0277867 A1
(43) Pub. Date: Sep. 27, 2018

(54) TIME-CONTROLLED CARTRIDGE HEATER FOR FUEL CELL KNOCK OUT DRAIN

(71) Applicant: FORD GLOBAL TECHNOLOGIES, LLC, Dearborn, MI (US)

(72) Inventor: Seha SON, Ann Arbor, MI (US)

(21) Appl. No.: 15/466,354

(22) Filed: Mar. 22, 2017

(51) Int. Cl. H01M 8/04223; H01M 8/04119; H01M 8/04007; H01M 8/04225

(52) U.S. Cl. CPC H01M 8/04253; H01M 8/04179; H01M 2250/20; H01M 8/04225; H01M 8/04037

(57) ABSTRACT

A vehicle is powered by a fuel cell system. The fuel cell system includes a water separator with a reservoir for accumulating water from the fuel cell system. A drain valve is coupled to a drain channel defined by the reservoir and is configured to drain water from the reservoir when opened. A cartridge heater is positioned within the drain channel proximate the drain valve. A controller is configured to activate the cartridge heater for a duration that varies based on an ambient temperature.

### TECHNICAL FIELD

This application generally relates to a heating system for a water removal system for a fuel cell.

### BACKGROUND

Vehicles may be powered by fuel cell systems. A fuel cell system generates electrical energy by chemical reactions caused by circulating hydrogen and oxygen through a fuel cell stack. A by-product of the chemical reactions is water. The fuel cell system must manage the accumulation of water by draining or recycling. In climates subject to freezing weather, additional challenges are present to prevent the water from freezing in the fuel cell system and causing blockages.

### SUMMARY

A vehicle includes a fuel cell system including a reservoir for water. The vehicle further includes a drain valve coupled to a drain channel defined by the reservoir and configured to drain water from the reservoir when opened. The vehicle further includes a cartridge heater positioned within the drain channel and proximate the drain valve. The vehicle further includes a controller configured to, in response to a fuel cell startup request, activate the cartridge heater for a duration that varies based on an ambient temperature.

The cartridge heater may be coupled to the reservoir at a surface of the reservoir opposite the drain channel. The cartridge heater may include a heated section proximate the drain valve that extends a distance from the drain valve based on an expected ice level in the reservoir during freezing conditions. The cartridge heater may be cylindrically shaped. A diameter of the cartridge heater may be such that an area of a channel opening defined by a cross-sectional area of the drain channel and a cross-sectional area of the cartridge heater within the drain channel is at least equivalent to an area defined by a two-millimeter diameter circular opening. The controller may be further configured to, in response to expiration of the duration, open the drain valve. The cartridge heater may be configured such that a tip of the cartridge heater that is proximate the drain valve is heated. The cartridge heater may be a split-sheath type.

A fuel cell system includes a reservoir configured to collect water, a drain valve coupled to a drain channel defined by the reservoir and configured to drain water from the reservoir when opened, a cartridge heater positioned within the drain channel and proximate the drain valve, and a controller configured to, in response to a fuel cell startup request, activate the cartridge heater for a duration that varies based on an ambient temperature.

The cartridge heater may be coupled to the reservoir at a surface of the reservoir opposite the drain channel. The cartridge heater may include an unheated section proximate the surface that extends a distance from the surface based on an expected ice level in the reservoir during freezing conditions. The cartridge heater may include a heated section proximate the drain valve that extends a distance from the drain valve based on an expected ice level in the reservoir during freezing conditions. A tip of the cartridge heater and a plunger of the drain valve may be separated by at least a predetermined gap. The controller may be further configured to activate the cartridge heater at a power level that varies based on the ambient temperature. A cross-sectional area of the cartridge heater may be such that a channel opening defined by the drain channel when the cartridge heater is inserted is at least equivalent to an area represented by a two-millimeter circular opening.

A water removal system for a fuel cell includes a reservoir for collecting water from the fuel cell and defining a drain channel. The water removal system further includes a drain valve coupled to the drain channel and configured to drain water from the reservoir when opened. The water removal system further includes a cartridge heater coupled to a surface of the reservoir opposite the drain channel and extending into the drain channel and proximate the drain valve.

The water removal system may further include a controller programmed to, in response to a fuel cell startup request, activate the cartridge heater for a duration that varies based on an ambient temperature. A tip of the cartridge heater that is proximate the drain valve may be a heated tip. A diameter of the cartridge heater may be such that an area of a channel opening defined by a cross-sectional area of the drain channel and a cross-sectional area of the cartridge heater within the drain channel is at least equivalent to an area defined by a two-millimeter diameter circular opening. The cartridge heater may include a heated section proximate the drain valve that extends a distance from the drain valve based on an expected ice level in the reservoir during freezing conditions.

### BRIEF DESCRIPTION OF THE DRAWINGS

FIG. 1 illustrates a block diagram of a vehicle powered by a fuel cell system.

FIG. 2 illustrates a schematic of a fuel cell system according to an embodiment.

FIG. 3 illustrates a possible configuration for a drain valve and a water separator that incorporates a cartridge heater.

FIG. 4 illustrates the drain valve and the water separator when the vehicle is on an inclined surface.

FIG. 5 depicts the drain valve and the water separator when the drain valve is open.

FIG. 6 depicts the drain valve and the water separator when the drain valve is closed and depicts a drain channel created by the cartridge heater.

FIG. 7 depicts the drain valve and the water separator when the drain valve is open and depicts the drain channel crated by the cartridge heater.

FIG. 8 depicts graphs of time to initiate drainage through a two-inch layer of ice at a range of starting temperatures.

FIG. 9 depicts graphs of cartridge heater temperature caused by operating in a dry water separator for durations selected according the starting temperatures.

FIG. 10 depicts a flow chart of a possible sequence of operations for operating the cartridge heater.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

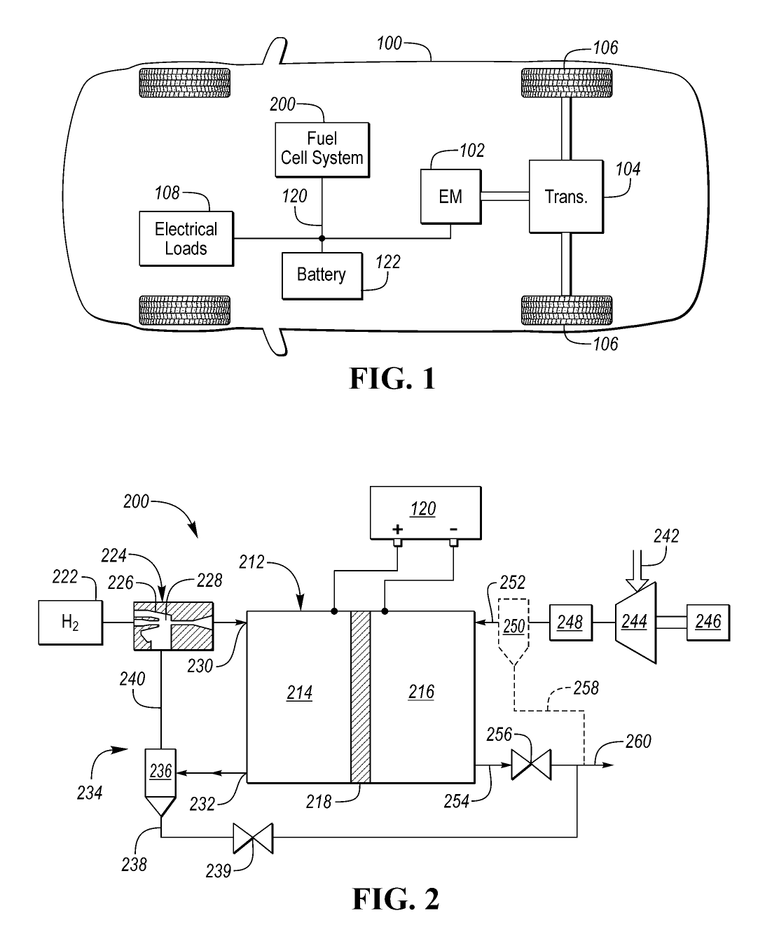

FIG. 1 depicts a diagram of a vehicle 100. The vehicle 100 may be powered by a fuel cell system 200. The fuel cell system 200 may be electrically coupled to a high-voltage bus 120. A traction battery 122 may be electrically coupled to the high-voltage bus 120. Electrical loads 108 may be electrically coupled to the high-voltage bus 120. An electric machine 102 may be electrically coupled to the high-voltage bus 120 via a power inverter. The electric machine 102 may be mechanically coupled to a transmission 104. The transmission 104 may be mechanically coupled to drive wheels 106 of the vehicle.

The fuel cell system 200 may provide electrical power to operate the electric machine 102 to propel the vehicle 100 or perform other vehicle functions. The fuel cell system 200 may generate electrical power that may be consumed by the components coupled to the high-voltage bus 120 (e.g., electrical loads 108). Electrical power generated by the fuel cell system 200 may also be stored by the traction battery 122. The electric machine 102 converts the electrical energy into rotational mechanical energy to drive the transmission 104. The transmission 104 may include gears and clutches that are configured to translate the rotational energy of the electric machine 102 into rotational energy at the drive wheels 106.

FIG. 2 illustrates one possible configuration of the fuel cell system 200 as a process flow diagram. The fuel cell system 200 may be a proton exchange membrane fuel cell (PEMFC) as is known in the art. The fuel cell system 200 may contain a fuel cell stack 212. The stack 212 may include an anode side 214, a cathode side 216, and a membrane 218 therebetween. The fuel cell system 200 may electrically communicate with and provide energy, for example, to the high voltage bus 120 or the traction battery 122. The fuel cell stack 212 may also have a cooling loop (not shown).

During operation of the fuel cell system 200, water, residual fuel such as hydrogen, and byproducts such as nitrogen, may accumulate at the anode side 214 of the fuel cell stack 212. The fuel cell system 200 may be configured to remove the liquid water and byproducts and to reuse the residual hydrogen and water vapor. One approach may be to collect those constituents in a separator 236 downstream of the fuel cell stack 212 that is configured to separate at least a portion of the liquid water and/or nitrogen and return the remaining constituents to the fuel cell stack 212 via a return passageway in a recirculation loop.

A primary fuel source 222 may be connected to the anode side 214 of the fuel cell stack 212, such as a primary hydrogen source. Non-limiting examples of the primary hydrogen source 222 may include a high-pressure hydrogen storage tank or a hydride storage device. The hydrogen source 222 may be connected to one or more ejectors 224. The ejector 224 may have a nozzle 226 supplying hydrogen into the converging section of a converging-diverging nozzle 228. The diverging section of the nozzle 228 may be connected to the input 230 of the anode side 214.

The output 232 of the anode side 214 may be connected to a passive recirculation loop 234. Typically, an excess of hydrogen gas is provided to the anode side 214 to ensure that there is sufficient hydrogen available to all the cells in the stack 212. In other words, hydrogen is provided to the fuel cell stack 212 above a stoichiometric ratio of one, i.e. at a fuel rich ratio relative to exact electrochemical needs. The recirculation loop 234 is provided such that excess hydrogen unused by the anode side 214 is returned to the input 230 so the excess may be used and not wasted.

Additionally, accumulated liquid and vapor phase water is an output of the anode side 214. The anode side 214 requires humidification for efficient chemical conversion and to extend membrane life. The recirculation loop 234 may be used to provide water to humidify the hydrogen gas before the input 230 of the anode side 214.

The recirculation loop 234 may include the separator 236, or water knock-out device. The separator 236 receives a stream or fluid mixture of hydrogen gas, nitrogen gas, and water from the output 232 of the anode side 214. The water may be mixed phase and contain both liquid and vapor phase water. The separator 236 may include a reservoir for holding a predetermined volume of water. The separator 236 removes at least a portion of the liquid phase water, which may exit the separator through drain line 238. At least a portion of the nitrogen gas, hydrogen gas, and vapor phase water may also exit the drain line 238, and pass through a control valve 239 (may also be referred to as a drain valve), for example, during a purge process of the fuel cell stack 212. The control valve 239 may be closely integrated with the separator 236. The remainder of the fluid in the separator 236 exits through passageway 240 in the recirculation loop 234, which is connected to the ejector 224. The fluid in passageway 240 is fed into the converging section of the converging-diverging nozzle 228 where it mixes with incoming hydrogen from the nozzle 226 and hydrogen source 222.

Liquid water may be removed from the anode side 214 by the separator 236 to prevent water blockages within the channels and cells of the anode side 214. Water blockages within the fuel cell stack 212 may lead to decreases in cell voltage and/or voltage instabilities within the fuel cell stack 212. Liquid water may also be removed by the separator 236 to prevent a blockage or partial blockage within the ejector 224. A liquid water droplet in the diverging section of the converging-diverging nozzle 228 would effectively create a second venturi section within the nozzle 228 and lead to pumping instabilities for the ejector 224.

The cathode side 216 of the stack 212 receives oxygen, for example, as a constituent in an air source 242. In one embodiment, a compressor 244 is driven by a motor 246 to pressurize the incoming oxygen. The pressurized air is then humidified by a humidifier 248 before entering the cathode side 216. Another separator 250 (shown in phantom) may be positioned downstream of the humidifier 248. The separator 250 may be used to remove liquid water from the humidified air flow before it enters the cathode side 216 of the stack 212 at input 252. Water droplets may be present downstream of the humidifier 248 due to liquid water being entrained by air high flow rates within the humidifier 248. Liquid water may be removed by the separator 250 to prevent water blockages within the cells of the cathode side 216, leading to decreases in cell voltage and/or instabilities within the fuel cell stack 212. The cathode stack outlet 254 of the cathode side 216 is connected to a valve 256. Drain line 238 from separator 236, and a drain line 258 from separator 250 may be connected to a line 260 downstream of the valve 256. In other embodiments, the drain lines may be plumbed to other locations in the fuel cell system 200.

Other system architectures may also be used for the fuel cell system 200. For example, a turbine may be used in addition to the compressor 244 to induce flow through the cathode side 216. In one example, a turbine is positioned downstream of the cathode stack outlet 254, with a separator interposed between the cathode side 216 and the turbine to remove liquid water before the fluid stream enters the turbine.

Based on the use of the ejector 224 to create flow through the anode side 214 and induce flow through the passive recirculation loop 234, the ejector 224 must overcome any pressure drops in the system, which includes a typically significant pressure drop across the fuel cell stack 212. The system 200 as shown does not include a pump or other device to induce flow in the recirculation loop 234, therefore all the compression work is accomplished by the ejector, otherwise described as a jet pump. To enable this function, the separator 236 may have a low pressure drop across it. The separator 236 may be configured to remove larger droplets of water from the fluid to prevent water blockages in the recirculating flow in the fuel cell stack 212 or ejector 224 caused by droplets. The separator 236 permits vapor phase water and smaller water droplets to remain in the recirculating flow in passageway 240 and return to the ejector 224 for humidification purposes. In one example, the separator 236 removes water droplets having a diameter on the order of one millimeter or larger.

Additionally, as the separator 236 receives fluid flow from the anode side 214, the separator 236 may be designed for use with hydrogen gas. Generally, hydrogen gas may cause material degradation or embrittlement issues and material used in the separator 236 may be hydrogen compatible. Additionally, hydrogen is a small molecule, and many conventional separator devices are not suitable for use with hydrogen because their design may permit leaks, for example, with a conventional threaded connection. Other conventional separators may contain rotating or moving parts, such as a rotating vane, or the like, which may not be compatible with hydrogen as the lubricant may poison the fuel cell stack, or the hydrogen may degrade or decompose the lubricant.

Separator 250 also needs to remove larger droplets of water from the fluid to prevent water blockages caused by droplets in the flow in the cathode side 216 of the fuel cell stack 212. The separator 250 permits vapor phase water, and smaller water droplets to remain in the flow for humidification. In one embodiment, the separator 250 removes water droplets that are the same size or larger than the cathode side 216 flow field channel widths. In one example, the cathode side flow field channels may be between 0.2 and 1.0 millimeters.

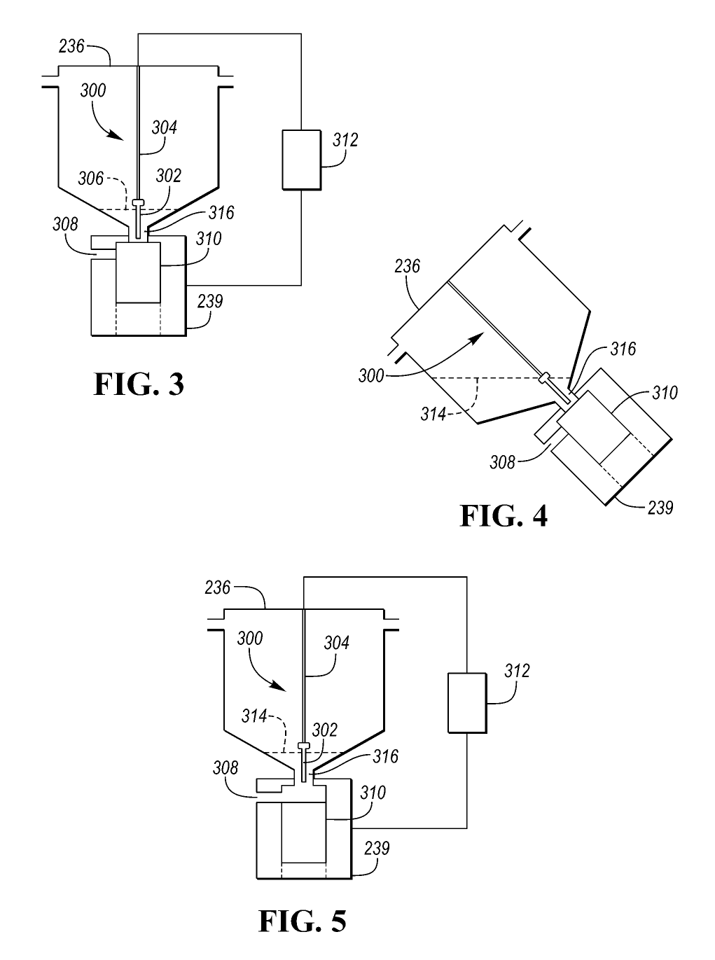

FIG. 3 depicts a possible configuration for the separator 236 and a drain valve 239. The features to be described are related to the separator 236 performing the function of accumulating and removing liquid water from the fuel cell system 200. The drain valve 239 may be a solenoid valve that includes a movable piston or plunger 310 that is configured to move when the solenoid is energized or activated. The drain valve 239 may be coupled to the separator 236 such that an input port of the drain valve 239 is attached to a fluid outlet or a drain channel 316 of the separator 236. The drain channel 316 may be a portion of the separator 236 defined at a bottom of the reservoir such that when oriented vertically, liquid water accumulates in the drain channel 316. An outlet port 308 of the drain valve 239 may be configured to permit fluid to flow from the separator 236 when the solenoid is energized. The drain valve 239 may be a normally closed valve. In the closed state, the plunger 310 may seal any passages between the input port and outlet port 308 of the drain valve 239. In the open state, the plunger 310 is positioned such that fluid flow between the input port and the outlet port 308 is allowed. Additional conduits may be coupled to the outlet port 308 to transport water exiting the separator for recirculation or removal.

During fuel cell operation, water may collect in the separator 236. The fuel cell system may control a water level 306 within the separator 236 to a predetermined level. During fuel cell operation, there may be a preferred water level for operating the fuel cell system 200. Further, during shutdown, the fuel cell system 200 may be configured to purge water from the separator 236 to prepare for the next operating cycle. The purge of water may also reduce the risk of freezing in cold weather. During fuel cell operation, the drain valve 239 may be periodically actuated to allow water to flow out of the separator 236 to maintain the preferred water level.

FIG. 4 depicts the separator 236 when the vehicle 100 is on an inclined surface. It is observed that a tilted water level 314 may still cover the drain channel 316 such that water may still be removed from the separator 236 by actuating the plunger 310.

FIG. 5 depicts the separator 236 with the plunger 310 in the open position (e.g., solenoid energized). It is observed that when the plunger 310 is in the open position, the drain channel 316 is fluidly connected to the outlet port 308. As such, accumulated water in the separator 236 may flow through the drain channel 316 to the outlet port 308. In this manner, the water level in the separator 236 may be reduced.

Water that is collected in the separator 236 poses problems in freezing weather conditions. After some time in below-freezing temperatures, water within the fuel cell system 200 may freeze to form ice. Frozen water in the separator 236 can block the drain channel 316 and prevent water from exiting the separator 236. In addition, water may freeze around the plunger 310 and prevent movement of the plunger 310. Ice in the separator 236 can cause the water level to become too high and eventually impede optimal operation of the fuel cell system 200. As such, various systems may be employed to reduce the occurrence of ice in the fuel cell system 200.

Prior solutions include the use of a scavenged reservoir which is a smaller reservoir that the separator drains into. The drain valve is then attached to an outlet of the scavenged reservoir. In the scavenged reservoir configuration, the drain valve is at a higher level than the scavenged reservoir. Water may freeze in the scavenged reservoir and eventually exceed the volume capacity of the scavenged reservoir leading to a blockage. On inclined surfaces, water in the scavenged reservoir may freeze leading to blockages. In addition, moisture near the drain valve can cause freezing leading to the need for a heated drain valve. Other solutions include the use of a heated drain valve. A heated drain valve functions to permit movement of the valve, but does not necessarily melt ice to initiate drainage.

Referring again to FIG. 3, a cartridge heater 300 may be installed within the separator 236 to prevent water freezing. The cartridge heater 300 may include a heated section 302 and a non-heated section 304. The heated section 302 may include a heating element. The heating element may be a resistive element that generates heat as current flows through. The heated section 302 may be positioned with the drain channel 316 and be proximate the drain valve 239. The cartridge heater 300 may be coupled to the separator 236 at a surface opposite the drain channel 316. For example, the cartridge heater 300 may be suspended or otherwise coupled to an upper-most surface of the separator 236. The non-heated section 304 may pass conductors for coupling the cartridge heater 300 to a controller 312. The cartridge heater 300 may be configured as a rigid shaft to minimize movement. The cartridge heater 300 may be installed such that the heated section 302 is within the drain channel 316 defined by the separator 236. To maintain a fixed position within the drain channel 316, a threaded bushing or flange may be utilized to secure the cartridge heater 300 to the separator 236.

The length of the heated section 302 proximate the drain valve may extend a distance from the drain valve 239 based on an expected ice level in the reservoir during freezing conditions. The length of the heated section 302 may be configured such that the heated section 302 extends a distance from a tip of the heated section 302 proximate the drain valve 239 to a maximum expected ice or water surface thickness within the separator 236. That is, the heated section 302 should extend from the drain valve 239 through any formed ice to facilitate melting. The heated section 302 may be sized such that activating the heating element melts a channel that allows water that is added to the separator to flow through to the drain channel 316. Extension of the heated section 302 above the maximum expected ice/water level does not aid in melting the ice and may increase power usage.

The normal opening of the drain channel 316 may be desired to be between 2 millimeters and 5 millimeters. Insertion of the cartridge heater 300 may change an effective opening of the drain channel 316. As such, design parameters may be selected to ensure that the effective opening is satisfactory for fuel cell operation. A diameter of the cartridge heater 300 may be such that an area of a channel opening defined by a cross-sectional area of the drain channel 316 and a cross-sectional area of the cartridge heater 300 within the drain channel 316 is at least equivalent to an area defined by a two-millimeter diameter circular opening. For example, assume a circular drain channel having a diameter of 5 millimeters. A commercially available cartridge heater may have a diameter of ⅛ inch (3.175 millimeters). Inserting the ⅛-inch cartridge heater in the 5-millimeter opening leaves an opening equivalent to a 3.86-millimeter diameter circular opening. Similar analysis may be performed for other configurations. By proper selection of the diameters of the drain channel 316 and the cartridge heater 300, adequate flow through the drain channel 316 may be ensured. Note that other combinations are possible in addition to the example presented.

A tip of the heated section 302 may be adjacent the plunger 310. The cartridge heater 300 may be configured with a heated tip to facilitate melting ice that may impede movement of the plunger 310. A predetermined gap may be present between the tip and the plunger 310 such that the tip does not contact the plunger 310. Although no contact between the drain channel 316 and the cartridge heater 300 may be desired, contact is not necessary harmful as the expected temperatures are not anticipated to adversely affect any of the surfaces. However, the gap may be preferred to prevent impeding the motion of the plunger 310.

The cartridge heater 300 may be cylindrically shaped. In some configurations, the cartridge heater 300 may be a split-sheath type cartridge heater. The split-sheath cartridge heater includes two legs that may expand when the heater is activated. Additionally, when the heater is deactivated, the legs may contract back to their original position. This may aid in increasing the size of the drain passage melted into the ice.

The non-heated section 304 may function as a conduction barrier so that wires that lead outside of the separator 236 remain near the ambient temperature. This avoids heat cycles of the wiring and insulation that may lead to degradation.

The cartridge heater 300 may be electrically coupled to the controller 312. The controller 312 may activate the heating element within the heated section 302 to cause an increase in temperature. The controller 312 may be configured to vary the power supplied to the cartridge heater 300. For example, the controller 312 may include a solid-state driver circuit that can vary the current supplied to the cartridge heater 300. For example, a pulse-width modulated signal may be provided to modulate the current flowing through the cartridge heater 300.

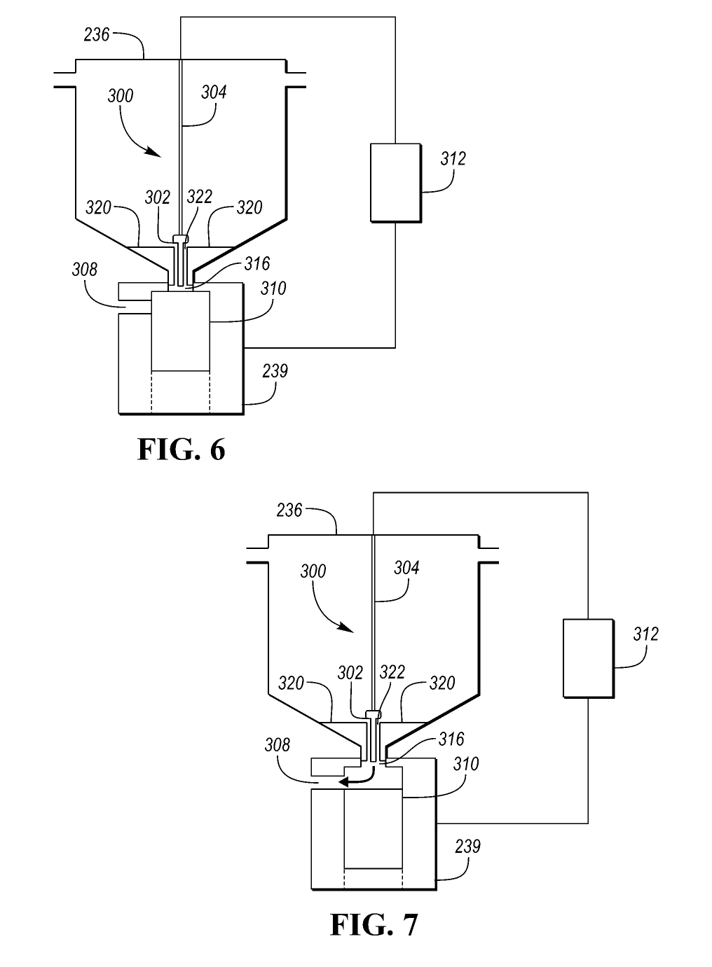

FIG. 6 depicts the separator in a frozen condition. Water in the separator 236 may freeze to form ice 320. The thickness of the ice may depend on the water level in the separator 236, temperature, and duration in the freezing conditions. Prior to any heating, the ice 320 may completely block the drain channel 316. Water entering the separator 236 is prevented from draining in this condition. The controller 312 may be configured to activate the cartridge heater 300 to melt the ice 320. At fuel cell startup, the cartridge heater 300 may be activated for a duration of time. When activated, the heated section 302 of the cartridge heater 300 causes the adjacent ice to melt. In addition, the tip of the heated section 302 causes heating of the plunger 310. The result of the heating is that a channel 322 is formed between the ice 320 and the heated section 302. In addition, any ice adjacent the plunger 310 is melted. The channel 322 that is formed may be generally shaped like the cartridge heater 300. As the fuel cell operates, the temperature of the air and water entering the separator 236 will increase causing further melting.

The heating process may be repeated. For example, after a predetermined off-time, the cartridge heater 300 may be activated again. The predetermined off-time may be selected to ensure that the cartridge heater 300 is below a predetermined temperature. Repeating the process may also be triggered by other sensors. For example, a water level sensor in the separator 236 may indicate that the water level is not decreasing as expected. Other performance measures of the fuel cell operation may also indicate that the separator 236 is not draining properly. These conditions may trigger another heating cycle to try and remove any remaining ice that may be blocking the flow of water.

Actuation of the plunger 310 couples the drain channel 316 to the outlet port 308 as depicted in FIG. 7. As such, the channel 322 create by cartridge heater 300 allows water to flow to the outlet port. As the fuel cell operates, additional water at a temperature above freezing will be added to the separator 236. The additional water added will cause further melting of the ice 320.

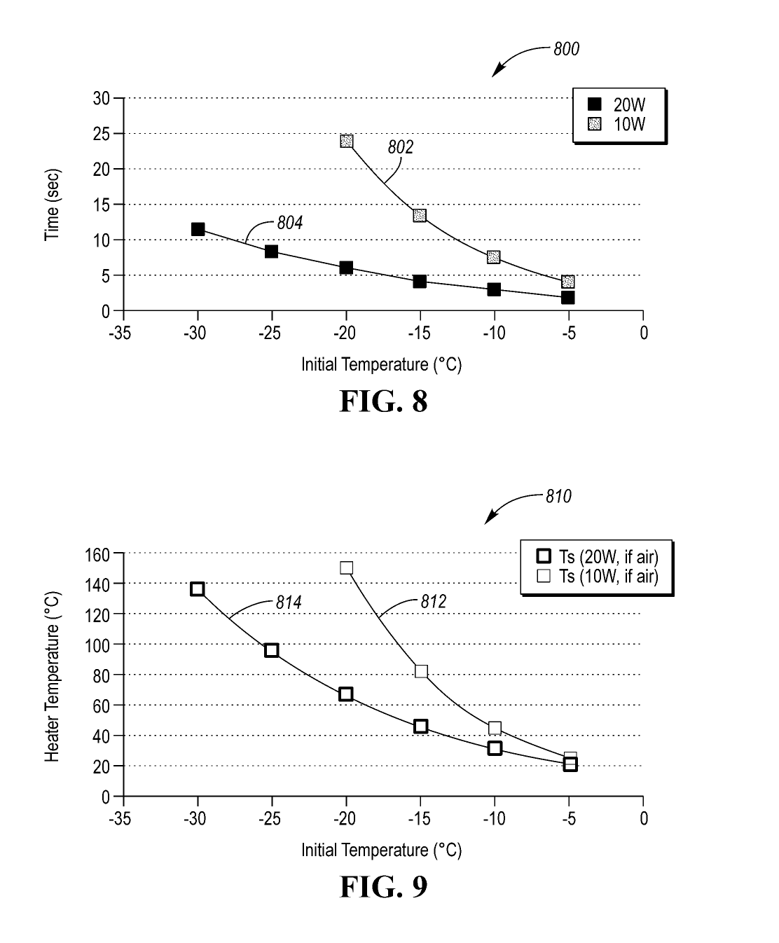

FIG. 8 depicts a graph 800 that depicts an amount of time to melt a passage through two-inch-thick ice for two different power levels. The graph 800 represents an example in which the heater cartridge is an eighth inch diameter cartridge heater having a length of two inches. A first curve 802 depicts the time to drainage for the heater operating at 10 Watts. A second curve 804 depicts the time to drainage for the heater operating at 20 Watts. The graph 800 assumes conditions in which the ice is a thickness of two inches in the separator 236. The first curve 802 and the second curve 804 depict the duration of time to melt a drainage path starting at a range of initial temperatures. For example, the time to initiate drainage through a two-inch-thick ice block at −25° C. using 20 Watts of power is 8.3 seconds.

FIG. 9 depicts a graph 810 that depicts the heater temperature when the heating element is activated for durations as specified in FIG. 8 under dry conditions. The graph 810 shows the temperature of the heater cartridge in the event of being activated for a duration without ice in the separator 236. A first temperature curve 812 corresponds to activating the heater at 10 Watts. A second temperature curve 814 corresponds to activating the heater at 20 Watts. For example, the maximum temperature achieved starting at −25° C. using 20 Watts of power for a duration of 8.3 seconds when there is no ice/water present is 96° C.

Even assuming a starting temperature of 50° C. (122° F.), applying the heater at 20 Watts for 8.3 seconds results in a heater temperature of 171° C. It may be desired to prevent the heater from causing temperatures that may cause system degradation. The system may be designed to prevent high temperatures and/or utilize materials that can withstand high temperatures. One possible weak area in a cartridge heater system may be the connection point of the lead wires. If the lead wires are sheathed in Teflon, the temperature may be regulated to remain below 250° C. to prevent degradation of the sheathing. Another possible weak area is the face of the plunger 310. For example, the drain valve 239 may include a surface comprised of ethylene propylene diene monomer (EPDM) rubber. The EPDM rubber may provide the seal to prevent leakage when the valve is not activated. The EPDM rubber may degrade at temperatures above 150° C. However, as there is a gap between the heater tip and the plunger 310, the temperature at the face of the plunger 310 can be maintained within an acceptable range even under worst case conditions. For example, if the starting temperature is above a predetermined temperature level (e.g., 50° C.), then the heater may not be activated since freezing conditions are not suspected.

The cartridge heater 300 may be activated for a predetermined duration. The predetermined duration may be a function of the ambient air temperature at fuel cell startup. The vehicle 100 may include one or more temperature sensors. The temperature sensor may include an ambient air temperature sensor. The temperature sensors may be electrically coupled to the controller 312 or otherwise in communication with the controller 312.

An advantage of the heating system is that no additional sensors are required. For example, no temperature sensors monitoring the cartridge heater 300 are used. The cartridge heater 300 is operated for predetermined durations and power levels at which no degradation of the cartridge heater is expected. The durations are selected such that the cartridge heater 300 will not overheat or cause temperatures within the separator 236 to become excessive.

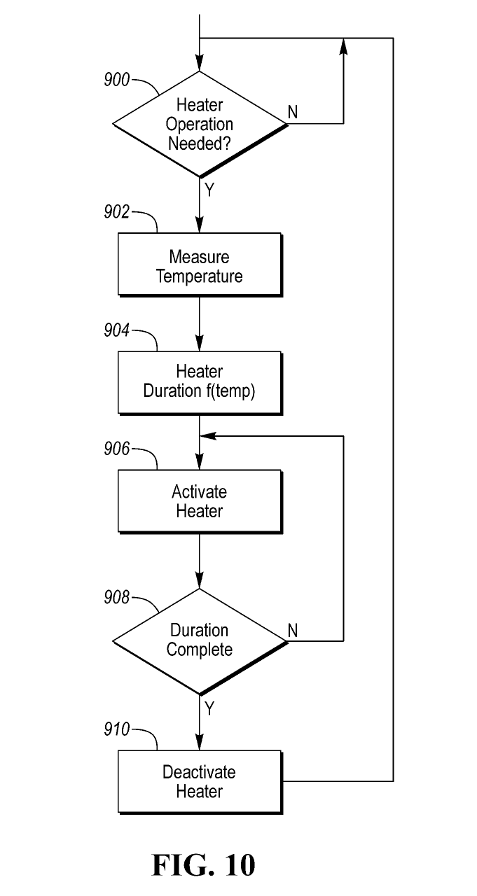

FIG. 10 depicts a flow chart for a possible sequence of operations that may be implemented in the controller 312. At operation 900, a check may be performed to determine if heater operation is needed. Heater operation may be requested during a fuel cell system startup procedure. For example, heater operation may be initiated in response to a fuel cell startup request. The fuel cell startup request may be derived from an ignition on request. Heater operation may be requested after the vehicle has been powered off for a predetermined time. If heater operation is not needed, then operation 900 may be repeated periodically.

If heater operation is needed, operation 902 may be performed. At operation 902, a temperature associated with the vehicle may be measured. For example, an ambient air temperature sensor may be sampled to determine a temperature of the environment. In other configurations, a temperature sensor of the fuel cell system 200 may be sampled.

At operation 904, a heater duration may be computed. For example, the heater duration may be a function of the measured temperature. The heater duration may be selected as depicted in FIG. 8 based on the temperature. The curves may be represented as a table and stored in memory of the controller 312. In some configurations, the heater duration may be a fixed interval. At operation 906, the heater may be activated by applying a voltage or current the heating element of the cartridge heater 300. When activated, the heated section 302 creates a channel through any accumulated ice so that water may drain from the separator 236. At operation 908, a check may be performed to determine if the duration is complete. If the duration is not complete, then operations 906 and 908 may be repeated periodically. If the duration is complete, operation 910 may be performed to deactivate the heater. After the heating cycle is completed (e.g., in response to expiration of the duration), the drain valve 239 may be activated to initiate drainage. After the heating cycle is complete, execution may return to operation 900 to repeat the cycle if needed.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle comprising:
a fuel cell system including a reservoir for water;
a drain valve coupled to a drain channel defined by the reservoir and configured to drain water from the reservoir when opened;
a cartridge heater positioned within the drain channel and proximate the drain valve; and
a controller configured to, in response to a fuel cell startup request, activate the cartridge heater for a duration that varies based on an ambient temperature.

2. The vehicle of claim 1 wherein the cartridge heater is coupled to the reservoir at a surface of the reservoir opposite the drain channel.

3. The vehicle of claim 1 wherein the cartridge heater includes a heated section proximate the drain valve that extends a distance from the drain valve based on an expected ice level in the reservoir during freezing conditions.

4. The vehicle of claim 1 wherein the cartridge heater is cylindrically shaped.

5. The vehicle of claim 4 wherein a diameter of the cartridge heater is such that an area of a channel opening defined by a cross-sectional area of the drain channel and a cross-sectional area of the cartridge heater within the drain channel is at least equivalent to an area defined by a two-millimeter diameter circular opening.

6. The vehicle of claim 1 wherein the controller is further configured to, in response to expiration of the duration, open the drain valve.

7. The vehicle of claim 1 wherein the cartridge heater is configured such that a tip of the cartridge heater that is proximate the drain valve is heated.

8. The vehicle of claim 1 wherein the cartridge heater is a split-sheath type.

9. A fuel cell system comprising
a reservoir configured to collect water;
a drain valve coupled to a drain channel defined by the reservoir and configured to drain water from the reservoir when opened;
a cartridge heater positioned within the drain channel and proximate the drain valve; and
a controller configured to, in response to a fuel cell startup request, activate the cartridge heater for a duration that varies based on an ambient temperature.

10. The fuel cell system of claim 9 wherein the cartridge heater is coupled to the reservoir at a surface of the reservoir opposite the drain channel.

11. The fuel cell system of claim 10 wherein the cartridge heater includes an unheated section proximate the surface that extends a distance from the surface based on an expected ice level in the reservoir during freezing conditions.

12. The fuel cell system of claim 9 wherein the cartridge heater includes a heated section proximate the drain valve that extends a distance from the drain valve based on an expected ice level in the reservoir during freezing conditions.

13. The fuel cell system of claim 9 wherein a tip of the cartridge heater and a plunger of the drain valve are separated by at least a predetermined gap.

14. The fuel cell system of claim 9 wherein the controller is further configured to activate the cartridge heater at a power level that varies based on the ambient temperature.

15. The fuel cell system of claim 9 wherein a cross-sectional area of the cartridge heater is such that a channel opening defined by the drain channel when the cartridge heater is inserted is at least equivalent to an area represented by a two-millimeter circular opening.

16. A water removal system for a fuel cell comprising:
a reservoir for collecting water from the fuel cell and defining a drain channel;
a drain valve coupled to the drain channel and configured to drain water from the reservoir when opened; and
a cartridge heater coupled to a surface of the reservoir opposite the drain channel and extending into the drain channel and proximate the drain valve.

17. The water removal system of claim 16 further comprising a controller programmed to, in response to a fuel cell startup request, activate the cartridge heater for a duration that varies based on an ambient temperature.

18. The water removal system of claim 16 wherein a tip of the cartridge heater that is proximate the drain valve is a heated tip.

19. The water removal system of claim 16 wherein a diameter of the cartridge heater is such that an area of a channel opening defined by a cross-sectional area of the drain channel and a cross-sectional area of the cartridge heater within the drain channel is at least equivalent to an area defined by a two-millimeter diameter circular opening.

20. The water removal system of claim 16 the cartridge heater includes a heated section proximate the drain valve that extends a distance from the drain valve based on an expected ice level in the reservoir during freezing conditions.
